(19) United States
(12) Patent Application Publication
(10) Pub. No.: US 2026/0343395 A1
(43) Pub. Date: Oct. 29, 2026

(54) SYSTEM, METHOD, AND MEDIUM FOR ASSIGNING MULTIPLE NETWORK SLICES TO A SINGLE MOBILE PRIVATE NETWORK

(71) Applicant: Verizon Patent and Licensing Inc., Basking Ridge, NJ (US)

(72) Inventors: Deepak Chadaga, Coppell, TX (US); Tyler Kates, Austin, TX (US); Ambreen Habib, Golden, CO (US)

(21) Appl. No.: 19/189,699

(22) Filed: Apr. 25, 2025

(51) Int. Cl. H04W 48/18; H04B 17/391; H04W 72/543

(52) U.S. Cl. CPC H04W 48/18; H04B 17/3913; H04W 72/543

(57) ABSTRACT

A method, a network device, and a non-transitory computer-readable storage medium are described in relation to a multi-slice Mobile Private Network (MPN) service. The service may include presenting, to a user, a list of network slices available for use in an MPN; receiving, from the user, selection of a network slice, from the list of network slices, for the MPN, wherein the selected network slice is different than a default network slice for the MPN; and mapping the selected network slice to the MPN.

### BACKGROUND

Development and design of networks create new service opportunities from a network-side perspective and an end device perspective. With respect to Next Generation (NG) wireless networks, such as Fifth Generation New Radio (5G NR) networks, various mechanisms and technologies may be used to ensure the delivery of certain performance metrics, such as minimal latency and packet loss, as well as high throughput and other types of network performance criteria.

### BRIEF DESCRIPTION OF THE DRAWINGS

FIG. 1 illustrates concepts described herein;

FIG. 2 is a diagram illustrating an exemplary environment in which an embodiment of a multi-slice Mobile Private Network (MPN) service may be implemented;

FIG. 3 illustrating an exemplary portion of a network environment that may be used with the multi-slice MPN service, according to an implementation;

FIGS. 4A and 4B are diagrams illustrating communication among devices of a network portion to implement the multi-slice MPN service, according to an implementation;

FIG. 5 is a diagram illustrating components of a device that may correspond to one or more of the devices illustrated and described herein; and

FIG. 6 is a flow diagram illustrating an exemplary process of an embodiment of the multi-slice MPN service.

### DETAILED DESCRIPTION

The following detailed description refers to the accompanying drawings. The same reference numbers in different drawings may identify the same or similar elements. Also, the following detailed description does not limit the invention.

In current mobile networks, Mobile Network Operators (MNOs) offer a service that gives a customer (e.g., an enterprise customer) the ability to assign certain mobile cellular devices (e.g., devices designated to have their data traffic secure from the general Internet) to a Mobile Private Network (MPN). Similar to a Virtual Private Network (VPN), an MPN segregates traffic from selected mobile devices from general Internet traffic all the way to devices at a customer data center (e.g., such as an enterprise customer network). In current mobile networks, all traffic on the MPN is treated the same in terms of Quality of Service (QoS) priority, latency, bandwidth speeds, jitter, packet error loss, etc., generally referred to as a service level. Thus, if a customer desires different service levels over an MPN, a separate MPN is needed for each service level. These separate MPNs are hard to manage from a customer perspective and costly to implement and maintain from an MNO and customer standpoint. For example, the customer has to maintain separate routers for each MPN created, and the MNO has to dedicate resources to build each MPN and then maintain that MPN to the customer's router. Furthermore, building MPNs in current mobile networks does not scale, as it can become cost-prohibitive and introduce customer support challenges for the MNO.

Fifth Generation (5G) Stand Alone (SA) networks offer the possibility of network slicing. Network slicing is a type of virtualized networking architecture that involves partitioning of a single physical network into multiple virtual networks. The partitions, or "slices," of the virtualized network may be customized to meet the specific needs of applications, services, devices, customers, or operators. There are multiple network slices (potentially hundreds in the future) that can offer different service levels. If a 5G SA network were to follow the 4G Long-Term Evolution (LTE) paradigm of building MPNs, the enterprise customer would have to have an MPN built for each slice used by the customer. The customer would then request a certain number of devices be assigned to each MPN.

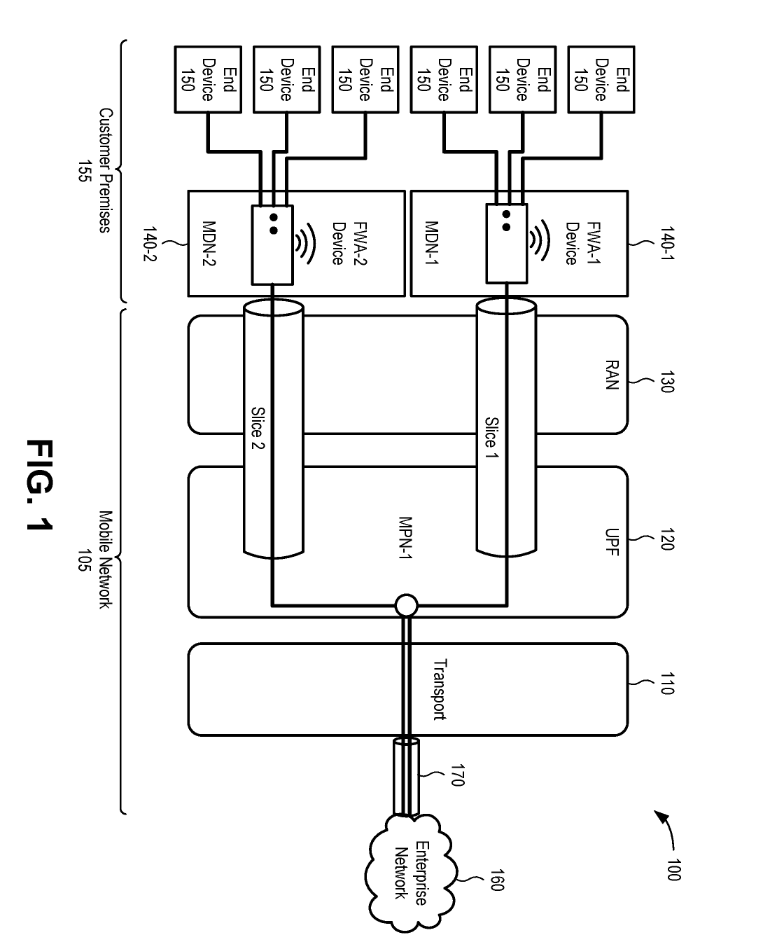

Systems and methods described herein ensure that multiple network slices can be mapped to a single MPN for a particular customer. FIG. 1 illustrates concepts described herein in the context of an exemplary network environment 100 which may be configured using a multi-slice MPN service according to implementation described herein.

As shown in FIG. 1, network environment 100 may include a transport network 110, a user plane function (UPF) 120, a Radio Access Network (RAN) 130, fixed wireless access (FWA) devices 140-1 and 140-2 (referred to herein collectively as FWA devices 140), end devices 150, and an enterprise network 160. In network environment 100, transport network 110, UPF 120, and RAN 130 may be considered part of a mobile network 105 operated by an MNO. End devices 150 associated with an enterprise customer may be connected to an enterprise customer network 160 (also referred to herein as a private network). FWA devices 140 and end devices 150 may be associated with customer premises 155.

Transport network 110 may include an X-haul network (e.g., backhaul, fronthaul, etc.) and/or another suitable transport and/or intermediary network. Transport network 110 may support communication between devices in customer premises 155 and enterprise network 160.

UPF 120 may be a network function in a 5G network, such as a 5G core network. UPF 120 may maintain an anchor point for intra/inter-RAT mobility, maintain an external Packet Data Unit (PDU) point of interconnect to a particular data network (e.g., an IP multimedia subsystem (IMS) network, an MPN, etc.), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an "end marker" to a node of RAN 130, and/or perform other types of user plane processes. UPF 120 may communicate with network functions (e.g., a Session Management Function (SMF)) in transport network 110.

RAN 130 may include a 5G NR access network. RAN 130 may enable end devices 150 and/or FWA devices 140 to connect transport network 110 for data services. RAN 130 may include wireless access stations (not shown in FIG. 1). Each wireless access station (such as a next generation Node B (gNB)) may service a set of end devices 150 and/or FWA devices 140 within the geographic area serviced by the wireless station.

FWA devices 140 may be installed in a designated service location at customer premises 155, such as a place of business, an office complex, etc. In order to provide guaranteed service levels of broadband service for each customer, a service provider may need to prequalify, coordinate, and/or manage the number of end devices 150 in a given coverage area which are allowed access to network services. A customer location may be served by FWA devices 140 that may be provided as customer premises equipment (CPE) by the MNO. According to an implementation, each FWA device 140 may have a designated unique identifier, such as a Mobile Directory Number (e.g., MDN-1, MDN-2) for mobile network 105. FWA devices 140 may connect to, or alternatively may also function as, a Wi-Fi® access point (AP) that provides short-range wireless access for end devices 150. Each end device 150 may have its own service profile and may connect to broadband Internet via an air interface (e.g., the RAN) using FWA devices 140.

According to an implementation, each of FWA devices 140-1 and 140-2 may be associated with a different network slice (e.g., "Slice 1" or "Slice 2") within the same customer MPN (e.g., "MPN-1"). Examples of network slices that may be implemented in the MPN may include a default network slice used for sessions not associated with another particular network slice; an enhanced Mobile Broadband (eMBB) network slice for Voice over Internet Protocol (VoIP) telephone calls and/or data sessions for accessing Internet websites; a massive Internet of Things (mIoT) network slice for IoT devices; an Ultra-Reliable Low Latency Communication (URLLC) network slice for URLLC communication, such as medical monitoring devices, autonomous vehicles, industrial automation, etc.; and/or other types of network slices. Numerous other types of slices, tailored for particular network traffic requirements, may be used.

End devices 150 may include devices that connect to enterprise network 160 via respective FWA devices 140-1 and/or 140-2, such as computing devices, mobile devices, IoT devices, security cameras, payment systems, etc.

Enterprise network 160 may include a private network (e.g., a customer network, an in-house network, etc.) which may include a local area network (LAN), a wide area network (WAN), or a combination of networks. Different enterprise networks 160 may have different network identifiers and each enterprise network 160 may have different security protocols and security systems. Enterprise network 160 may connect to transport network 110 via a VPN, a Private IP (PIP) connection, or another type of secure, segregated connection 170.

As shown in FIG. 1, end devices 150 may connect to one of FWA devices 140. End devices 150 may be connected to respective FWA devices by wired or wireless connections. Each FWA device 140-1 and 140-2 may be a termination point for a respective network slice (e.g., Slice 1 or Slice 2). Segregated connection 170 and FWA devices 140 serve as endpoints for an MPN tunnel (e.g., MPN-1) between enterprise network 160 and customer premises 155. Customer devices (e.g., under the same unique enterprise customer number) are capable of being mapped to one or more network slices associated with FWA devices 140. Two network slices are shown in the illustration of FIG. 1 for simplicity. In other implementations, more than two slices may be used in a single MPN, as described further herein. Furthermore, according to an implementation, slices may be configured with time constraints and/or periodicity for each network slice, such that a customer may reduce costs and use of network resources by activating one or more slices only during certain defined time periods.

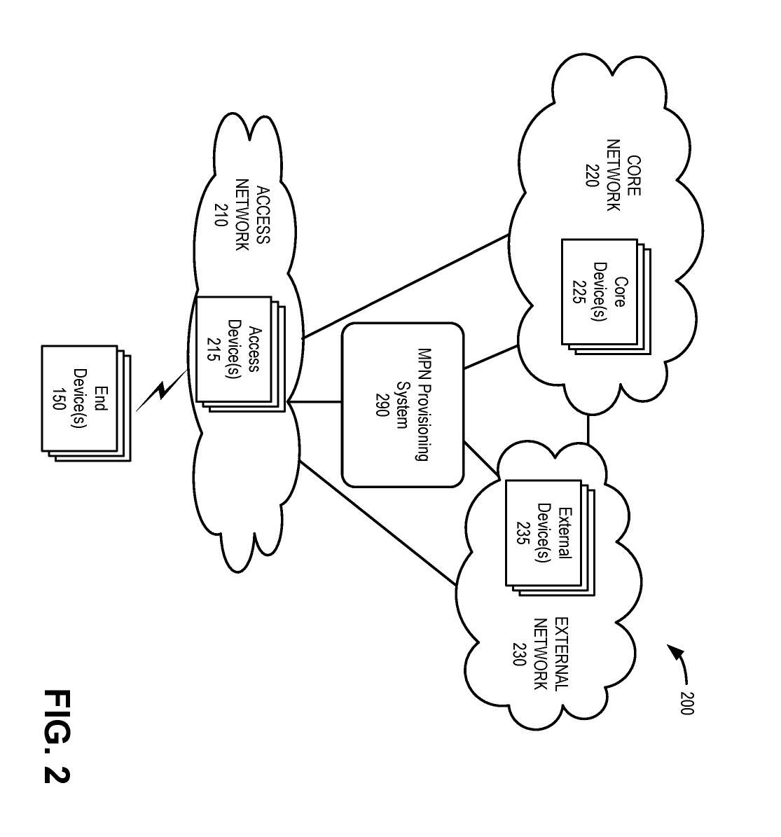

FIG. 2 is a diagram illustrating an environment 200 in which an exemplary embodiment of a multi-slice MPN service may be implemented. As illustrated, environment 200 includes an access network 210, a core network 220, and an external network 230. Access network 210, which may correspond to RAN 130 of FIG. 1, includes access devices 215 (also referred to individually or generally as access device 215). Core network 220 includes core devices 225 (also referred to individually or generally as core device 225). External network 230 includes external devices 235 (also referred to individually or generally as external device 235). Environment 200 further includes end devices 150 (also referred to individually or generally as end device 150) and a provisioning system 240.

The number, type, and arrangement of networks illustrated in environment 200 are exemplary. For example, according to other embodiments, environment 200 may include fewer networks, additional networks, and/or different networks. For example, according to other embodiments, other networks not illustrated in FIG. 2 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 200 includes communication links between the networks and between the network devices. Environment 200 may be implemented to include wired, optical, and/or wireless communication links. A communicative connection via a communication link may be direct or indirect. For example, an indirect communicative connection may involve an intermediary device and/or an intermediary network not illustrated in FIG. 2. A direct communicative connection may not involve an intermediary device and/or an intermediary network. The number, type, and arrangement of communication links illustrated in environment 200 are exemplary.

Environment 200 may include various planes of communication including, for example, a control plane, a user plane (UP), a service plane, and a network management plane. Environment 200 may include other types of planes of communication. A message communicated in support of the adaptive resource control service may use at least one of these planes of communication. According to various exemplary implementations, the interface of the network device may be a service-based interface, a reference point-based interface, an Open Radio Access Network (O-RAN) interface, a 5G interface, another generation of interface (e.g., 5G Advanced, Sixth Generation (6G), Seventh Generation (7G), etc.), or some other type of network interface (e.g., proprietary, etc.).

Access network 210 may include one or multiple networks of one or multiple types and technologies. For example, access network 210 may be implemented to include a 5G RAN, a future generation RAN (e.g., a 6G RAN, a 7G RAN, etc.), a centralized-RAN (C-RAN), a virtualized RAN (vRAN), an Open-RAN (O-RAN), and/or another type of access network. Access network 210 may include a legacy RAN (e.g., a Third Generation (3G) RAN, a Fourth Generation (4G) RAN, etc.). Access network 210 may communicate with and/or include other types of access networks, such as, for example, a Wi-Fi network, a LAN, a Citizens Broadband Radio System (CBRS) network, a cloud RAN, a self-organizing network (SON), a wired network (e.g., optical, cable, etc.), or another type of network that provides access to or can be used as an on-ramp to access network 210 and/or core network 220. In still other implementations, access network 210 may include a non-terrestrial network (NTN), such as a satellite-based network.

Access network 210 may include different and multiple functional splitting, such as options 1, 2, 3, 4, 5, 6, 7, or 8 that relate to combinations of access network 210 and core network 220 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA NR, SA NR, etc.). Additionally, or alternatively, according to some exemplary embodiments, access network 210 may be implemented to include various wired and/or optical architectures for wired and/or optical access services.

Depending on the implementation, access network 210 may include one or multiple types of network devices, such as access devices 215. For example, access device 215 may include a gNB, an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB, O-RAN-eNB), a 5G ultra-wide band (UWB) node, and/or a future generation wireless access device (e.g., a 5G advanced wireless station, a 6G wireless station, a 7G wireless station, or another generation of wireless station). Access devices 215 may include a transport device (e.g., a router or similar network device).

Access device 215 may include other types of wireless access devices, such as a Wi-Fi device, a hotspot device, and/or a fixed wireless access customer premise equipment (FWA CPE), etc.) that provides a wireless access service. Additionally, access devices 215 may include a wired and/or an optical device (e.g., modem, wired access point, optical access point, Ethernet device, multiplexer, etc.) that provides network access and/or transport service. According to some exemplary implementations, access device 215 may include a combined functionality of multiple radio access technologies (e.g., 4G and 5G functionality, 5G and 5G Advanced functionality, 5G and 6G), etc.) via soft and hard bonding based on demands and needs. According to some exemplary implementations, access device 215 may include a split access device (e.g., a CU-control plane (CP), a CU-user plane (UP), etc.) or an integrated functionality, such as a CU-CP and a CU-UP, or other integrations of split RAN nodes. Access device 215 may be located indoors or outdoors.

Core network 220 may include one or multiple networks of one or multiple network types and technologies. Core network 220 may include a complementary network of access network 210. For example, core network 220 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation, core network 220 may include diverse types of core devices 225. Core devices 225 may include, for example, a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), and/or a network exposure function (NEF). According to other exemplary implementations, core devices 225 may include additional, different, and/or fewer network devices than those described.

External network 230 may include one or multiple networks of one or multiple types and technologies that provide an application service. For example, external network 230 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 230 may be implemented to include a cloud network, a private network, an enterprise network, a public network, a Multi-access Edge Computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 230 may include various network devices, such as external devices 235. For example, external devices 235 may include virtual network devices (e.g., virtualized network functions (VNF), servers, host devices, application functions (AFs), application servers (AS), server capability servers (SCS), containers, hypervisors, virtual machines (VM), pods, network function virtualization infrastructure (NFVI), and/or other types of virtualization elements, layers, hardware resources, operating systems, engines, etc.) that may be associated with application services for use by end devices 150. By way of further example, external devices 235 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 230 may include one or multiple types of core devices 225, as described herein.

End device 150 may include a device that may have communication capabilities (e.g., wireless, wired, optical, etc.). End device 150 may or may not have computational capabilities. End device 150 may be implemented as a mobile device, a portable device, a stationary device (e.g., a non-mobile device and/or a non-portable device), a device operated by a user, or a device not operated by a user. For example, end device 150 may be implemented as a smartphone, a mobile phone, a personal digital assistant, a tablet, a netbook, a wearable device (e.g., a watch, glasses, headgear, a band, etc.), a computer, a gaming device, a music device, an IoT device, a drone, a smart device, an autonomous vehicle, or another type of wireless device (e.g., another type of user equipment (UE)). End device 150 may or may not be configured to execute diverse types of software (e.g., applications, programs, etc.). The number and the types of software may vary among end devices 150. End device 150 may include "edge-aware" and/or "edge-unaware" application service clients. End device 150 may be implemented as a virtualized device in whole or in part. For purposes of description, end device 150 is not considered a network device.

As further shown in FIG. 2, environment 200 may include an MPN provisioning system 290. MPN provisioning system 290 may include one or mor network devices that may implement aspects of the multi-slice MPN service, as described further herein. Provisioning system 290 may include a network provisioning system, a network management system, a self-optimizing network (SON) system, etc. Provisioning system 290 may manage the physical components of access network 210, core network 220, and/or external network 230. Provisioning system 290 may, for example, receive a service profile for a new network slice and create, based on the service profile, the new network slice that is configured to support the service profile.

Although MPN provisioning system 290 is depicted outside of access network 210, core network 220, and external network 230, such an illustration is exemplary. According to other exemplary implementations, MPN provisioning system 290 may reside in one or multiple networks depicted and described herein. Additionally, MPN provisioning system 290 may be implemented in a centralized, distributed, and/or another type of network and/or computing architecture as a network device or system, as described herein.

Although FIG. 2 shows exemplary components of environment 200, in other implementations, environment 200 may include fewer components, different components, differently arranged components, or additional components than depicted in FIG. 2. Additionally, or alternatively, one or more components of environment 200 may perform functions described as being performed by one or more other components of environment 200.

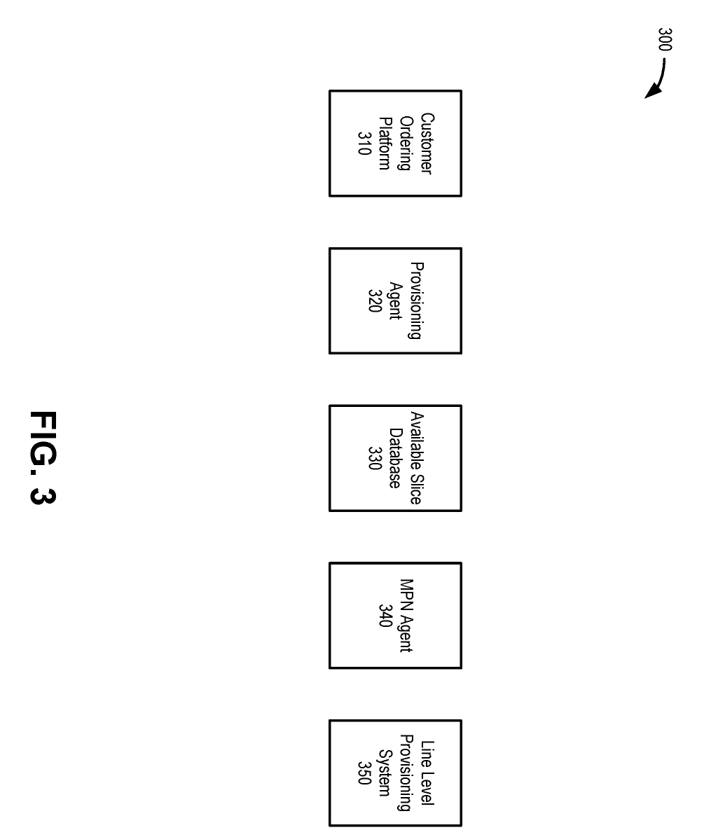

FIG. 3 is a diagram illustrating an exemplary portion 300 of environment 200 that may be used with the multi-slice MPN service. As shown in FIG. 3, portion 300 may include a customer ordering platform 310, a provisioning agent 320, an available slice database 330, an MPN agent 340, and a line level provisioning system 350. In one implementation, each of customer ordering platform 310, provisioning agent 320, slice database 330, MPN agent 340, and line level provisioning system 350 may be included within provisioning system 290. In other implementations, one or more elements of FIG. 3 may be included in another portion of network environment 200.

Customer ordering platform 310 may include one or more network devices that provide a web-based interface for a customer (e.g., using a user device, end device 150, etc.) to request MPN services. Via the particular customer device, the customer may access customer ordering platform 310 to manage (e.g., order, configure, issue commands, update, monitor, etc.) network slices to support new applications or services on the customer's MPN, for example. Using customer ordering platform 310, customers may enter their network slice/service configurations with selected eligible parameters supported by network environment 200. According to an implementation, customer ordering platform 310 may use a configuration questionnaire as an initial inquiry tool. The configuration questionnaire may list possible network functions or service attributes to select. Customer ordering platform 310 may be directly or indirectly submitted to a provisioning agent 320 in the form of a work order. For example, in one implementation, a system engineer (e.g., a person) may review input from customer ordering platform and create a customer work order to create or update an MPN based on the customer requirements.

Provisioning agent 320 may include a computer device or network device to assist in creating a work order for customer MPNs. For example, a system engineer may create a customer work order to create or update an MPN. Provisioning agent 320 may query slice database 330 for a listing of available slices supported with MPNs in the network (including slice attributes and supported devices). In one implementation, provisioning agent 320 may utilize a new application programming interface (API) to conduct discovery/requests for available slices for the MPN. Slice database 330 may return to provisioning agent 320 the full list of currently available network slices.

Provisioning agent 320 may process the full list of currently available network slices to determine which slices (if any) are currently associated with an MPN for the customer. For example, provisioning agent 320 may determine if a work order is a new order (e.g., for a new customer MPN) or a change order (e.g. to revise slice properties of an existing MPN for the customer). For a new work order, provisioning agent 320 may display to the system engineer the full list of the available slices obtained from slice database 330. The system engineer may choose the relevant slice(s) to connect to the MPN based on the customer requirements. For a change order, provisioning agent 320 may display to the system engineer an updated list of network slices, indicating which ones are already being used in the customer's MPN and which ones are new, so that the system engineer can make the change per customer requirements. Provisioning agent 320, upon receiving a new or updated work order, may verify slice information on the MPN level prior to line level provisioning.

According to an implementation, the multi-slice MPN service may include an MPN agent 340. MPN agent 340 may include an artificial intelligence and/or machine learning (AI/ML) system used for service qualification and work order preparation to determine the network usage and impact of adding new slices to the existing MPN and to validate that the existing MPN can support the additional slices. MPN agent 340 may predict, for example, whether the required Quality of Service (QoS) for a network slice can be achieved for a period in the current network environment and estimated future traffic for the existing MPN. According to an implementation, MPN agent 340 may also provide network optimization (bandwidth, policy, location, etc.) insight and capacity/dimensioning of the network or MPN "last mile" to allow for the new slices with the existing MPN build. In one implementation, MPN 340 may provide recommendations for slice selections based on customer parameters.

MPN agent 340 may include one or multiple types of models. For example, the models may include a time series model, a forecast model, a clustering model, and/or a classification model. The models may include a tree-based algorithm, a regressive algorithm, and/or another type of AI/ML algorithm or logic, such as Naïve Bayes, K-Nearest Neighbors, decision tree, Random Forest, gradient boosting, support vector machine, clustering via embedding, a dense neural network, a convolutional neural network, a recurrent neural network, and/or the like. MPN agent 340 may calculate network slice configuration information pertaining to a network slice and/or a geographic area based on various types of information, as described herein. MPN agent 340 may also use policies/rules, historical network performance information, network dependency information associated with a network (e.g., access network 210, core network 220, etc.), a network device (e.g., access device 215, core device 225, etc.), a network slice (e.g., a 5G QoS Identifier (5QI), etc.), a segment of a network slice, application services, and various network elements, as described herein, to determine whether the required QoS for a network slice can be achieved on an existing MPN.

Line level provisioning system 350 may include one or more network devices or computer devices to design and orchestrate network slices in a network section, such as network environment 100. Line level provisioning system 350 may provide the capability to associate a single UE device (e.g., end device 150) with a unique slice or the same UE device with multiple slices. Line level provisioning system 350 may receive instructions from provisioning agent 320 that identify one or more domains and/or network functions to orchestrate within network environment 100. Line level provisioning system 350, based on the instructions from provisioning agent 320, may initiate a process of orchestrating particular transport domains and/or network functions in network environment 100.

According to different embodiments, line level provisioning system 350 may include multiple sub-components such as, for example, a slice inventory, a runtime slice orchestrator, a network function virtualization orchestrator (NFVO), and a virtual network function manager (VNFM). The slice inventory may include a memory or database with an inventory of active (e.g., instantiated) slices associated with network environment 100. The runtime slice orchestrator may manage creation of network slices using information from provisioning agent 320. For example, the runtime slice orchestrator may be responsible for implementing instructions to instantiate, allocate, and activate network slices. The NFVO may create, remove, and/or update network functions, such as virtualized versions of core components (e.g., session management function (SMF), UPF, etc.) at a particular site (e.g., a data center, enterprise, multi-access edge computing (MEC), etc.). The VNFM may perform lifecycle management of particular VNFs, including instantiation, scaling, updating, and/or termination of particular VNFs based on instructions received from, for example, the runtime slice orchestrator.

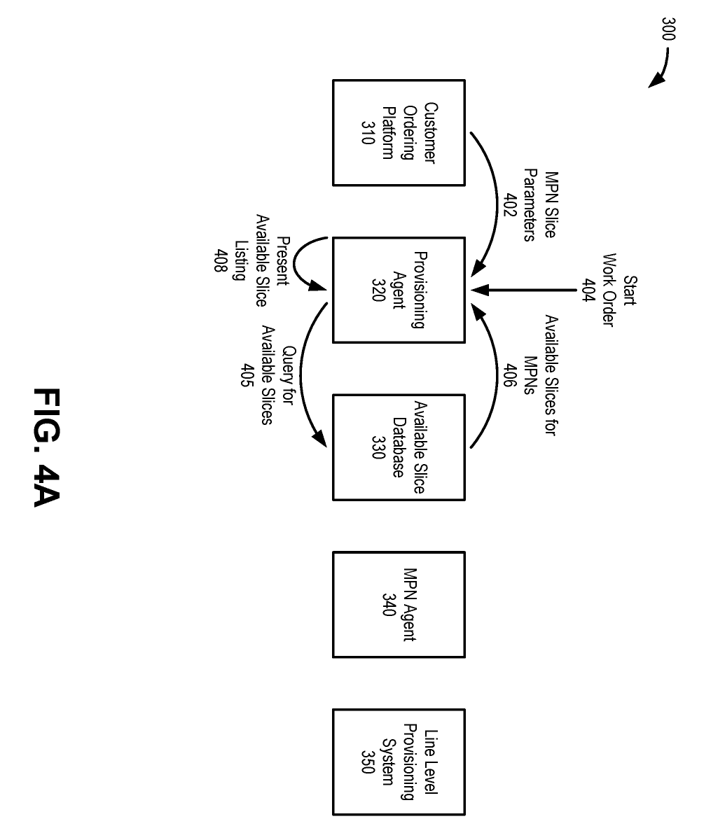

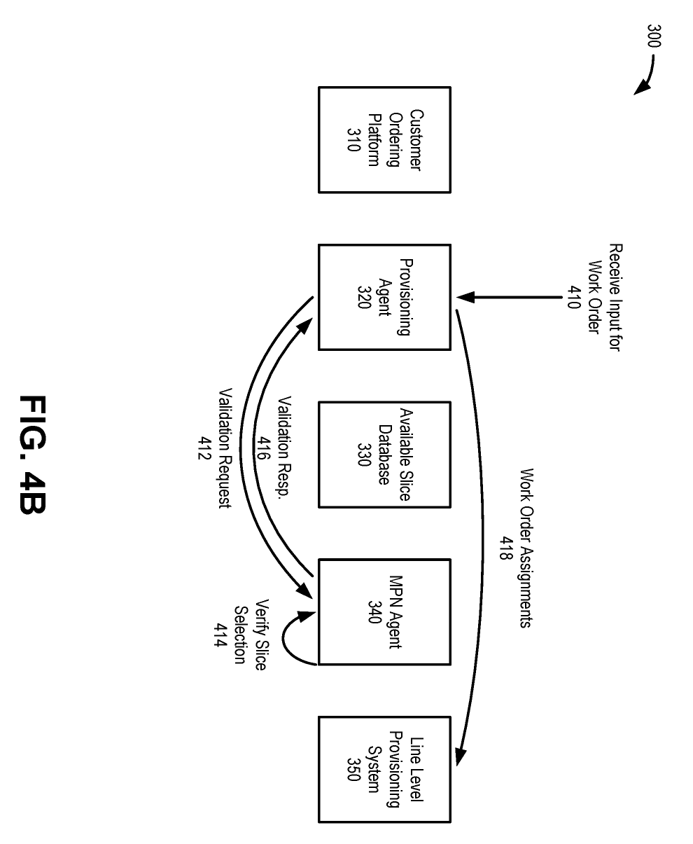

FIGS. 4A and 4B are diagrams illustrating communication among devices of network portion 300 to implement the multi-slice MPN service. As shown in FIG. 4A, customer ordering platform 310 may provide MPN slice parameters 402 to provisioning agent 320. For example, an enterprise customer may use customer ordering platform 310 to define parameters for one or more service levels and/or slices to be used within an MPN. MPN slice parameters 402 may include, for example, latency parameters, QoS, bandwidth parameters, packet loss limits, etc. According to an implementation, MPN slice parameters 402 may also include time constraints (e.g., a one-time use period) and/or periodicity (e.g., periodic times of availability) for a network slice (referred to herein generally as time constraints). For example, a customer may request a one-time use slice (e.g., to support a particular event) or a regular interval of slice usage (e.g., corresponding to regular work hours, weekly events, weekends, etc.). As an illustrative example, a customer may request a particular network slice be available from 6:00 AM to 6:00 PM every weekend in a particular region

Provisioning agent 320 may receive MPN slice parameters 402, which may allow a system engineer or AI/ML-based logic to begin to prepare a work order 404. For example, the work order may be used to eventually implement a new or updated MPN for the customer with the requested MPN slice parameters 402. The work order 404 may be associated with the specific customer, such as by using a unique customer identifier.

Provisioning agent 320 may provide a user interface for preparing the work order. The user interface may include a dynamic slice selection list for the specific customer. For example, in one implementation, provisioning agent 320 may provide a query 405 to slice database 330 for available network slices that are compatible with MPNs. In one implementation, a dedicated or modified API may be used to initiate query 405. Some exemplary parameters that may be included in the API are bandwidth and usage limitations, transport settings for the customer (e.g., VPN, Private IP, etc.), and latency measurements with the current data center.

Slice database 330 may receive query 405 and respond by providing a full list of available slices 406 supported with MPNs in the network environment 100 (including, for example, slice attributes and supported devices for each network slice). In one implementation, the list of available slices may be provided using the dedicated or modified API that initiated query 405.

Provisioning agent 320 may receive the list of available slices 406 and may determine if the work order (e.g., work order 404) is a new customer work order or a change work order for the customer. For example, provisioning agent 320 may determine, based on the unique customer identifier, whether or not the customer has an existing MPN. Provisioning agent 320 may display, on the user interface, a dynamic slice selection list for the specific customer that differentiates between unused slices and used slices in the MPN. For example, if work order 404 is a new work order, provisioning agent 320 may display 408 the full list of available slices (e.g., from list of available slices 406) to the system engineer to choose the relevant slices to connect to the MPN based on the customer requirements. Alternatively, if work order 404 is a change of work order, then provisioning agent 320 may update the list of available slices, distinguishing between which ones are already being used by the customer, and which ones are new, so that the system engineer can modify the MPN configuration in accordance with MPN slice parameters 402.

Referring to FIG. 4B, a system engineer may use display 408 to provide additional input 410 for the work order to create a draft work order. For example, the system engineer may select from the list of available slices to add a new slice for an existing MPN or to select slices for a new MPN according to the customer's parameters. According to an implementation, the additional input may also include time constraints and/or periodicity for customer access to one or more network slices. After the additional input 410, provisioning agent 320 may calculate a configuration for the selected network slice(s) on the MPN and send the draft work order to MPN agent 340 with a validation request message 412. Validation request message 412 may include, for example, a customer identifier, an MPN identifier (if available), the assigned slices, and any time constraints.

MPN agent 340 may receive validation request message 412 and verify the slice selection 414 on the MPN level. For example, MPN agent 340 may use AI/ML predictive modeling to determine the network usage and impact of adding the assigned new slices to the existing MPN. MPN agent 340 may confirm (or deny) that the existing MPN can support the additional slices, including use of the additional slices at any designated time periods. MPN agent 340 may provide a validation response message 416 to provisioning agent 320. In one implementation, if use of the selected slice(s) on the customer's MPN are not verified, validation response message 416 may include a recommendation for alternate slice selection that more closely fits customer requirements.

Assuming use of the selected slice(s) on the customer's MPN is verified in validation response message 416, provisioning agent 320 may forward the work order assignment 418 for the MPN to line level provisioning system 350. The work order assignment 418 may identify, for example, specific UE devices (e.g., end devices 150) or groups of devices that can have access to network slices, as originally indicated, for example, in MPN slice parameters 402. For example, work order assignment 418 may associate unique device identifiers (e.g., an International Mobile Subscriber Identity (IMSI), a Mobile Directory Number (MDN), a Mobile Station International Subscriber Directory Number (MSISDN), an International Mobile Equipment Identity (IMEI), or another type of UE device ID) with each network slice. Based on the work order assignment 418, line level provisioning system 350 may associate a single end device 150 with a unique slice or the same end device with multiple slices.

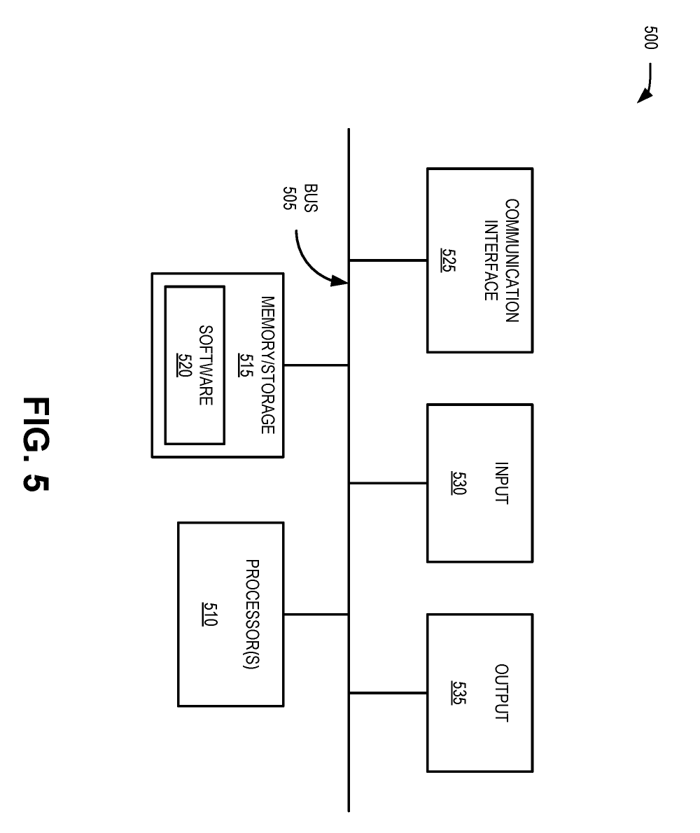

FIG. 5 is a diagram illustrating exemplary components of a device 500 that may be included in one or more of the devices described herein. For example, device 500 may correspond to end device 150, FWA device 140, access device 215, core device 225, external device 235, customer ordering platform 310, provisioning agent 320, slice database 330, MPN agent 340, line level provisioning system 350, and/or other types of network devices, as described herein. As illustrated in FIG. 5, device 500 includes a bus 505, a processor 510, a memory/storage 515 that stores software 520, a communication interface 525, an input 530, and an output 535. According to other embodiments, device 500 may include fewer components, additional components, different components, and/or a different arrangement of components than those illustrated in FIG. 5 and described herein.

Bus 505 includes a path that permits communication among the components of device 500. For example, bus 505 may include a system bus, an address bus, a data bus, and/or a control bus. Bus 505 may also include bus drivers, bus arbiters, bus interfaces, clocks, and so forth.

Processor 510 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 510 may be implemented as hardware (e.g., a microprocessor, etc.), a combination of hardware and software (e.g., a SoC, an ASIC, etc.), may include one or multiple memories (e.g., cache, etc.), etc.

Processor 510 may control the overall operation, or a portion of operation(s) performed by device 500. Processor 510 may perform one or multiple operations based on an operating system and/or various applications or computer programs (e.g., software 520). Processor 510 may access instructions from memory/storage 515, from other components of device 500, and/or from a source external to device 500 (e.g., a network, another device, etc.). Processor 510 may perform an operation and/or a process based on various techniques including, for example, multithreading, parallel processing, pipelining, interleaving, learning, model-based, etc.

Memory/storage 515 includes one or multiple memories and/or one or multiple other types of storage mediums. For example, memory/storage 515 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory, a solid state memory, and/or some other type of memory. Memory/storage 515 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 515 may be external to and/or removable from device 500, such as, for example, a Universal Serial Bus (USB) memory stick, a dongle, a hard disk, mass storage, off-line storage, or some other type of storing medium. Memory/storage 515 may store data, software, and/or instructions related to the operation of device 500.

Software 520 includes an application or a program that provides a function and/or a process. As an example, with reference to provisioning agent 320, software 520 may include an application that, when executed by processor 510, provides a function and/or a process of the multi-slice MPN service, as described herein. According to another example, with reference to MPN agent 340, software 520 may include an application that, when executed by processor 510, provides a function and/or a process of the multi-slice MPN service, as described herein. Software 520 may also include firmware, middleware, microcode, hardware description language (HDL), and/or another form of instruction. Software 520 may also be virtualized. Software 520 may further include an operating system (OS) (e.g., Windows, Linux, Android, proprietary, etc.).

Communication interface 525 permits device 500 to communicate with other devices, networks, systems, and/or the like. Communication interface 525 includes one or multiple wireless interfaces (e.g., radio frequency interfaces), optical interfaces, and/or wired interfaces. For example, communication interface 525 may include one or multiple transmitters and receivers, or transceivers. Communication interface 525 may operate according to a protocol stack and a communication standard.

Input 530 permits an input into device 500. For example, input 530 may include a keyboard, a mouse, a display, a touchscreen, a touchless screen, a button, a switch, an input port, speech recognition logic, and/or some other type of visual, auditory, tactile, affective, olfactory, etc., input component. Output 535 permits an output from device 500. For example, output 535 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 500 may be implemented in the same manner. For example, device 500 may be instantiated, created, deleted, or some other operational state during its life cycle (e.g., refreshed, paused, suspended, rebooted, or another type of state or status), using well-known virtualization technologies. For example, access device 215, core device 225, external device 235, and/or another type of network device or end device 150, as described herein, may be a virtualized device.

Device 500 may be configured to perform a process and/or a function, as described herein, in response to processor 510 executing software 520 stored by memory/storage 515. By way of example, instructions may be read into memory/storage 515 from another memory/storage 515 (not shown) or read from another device (not shown) via communication interface 525. The instructions stored by memory/storage 515 may configure device 500 and/or cause processor 510 to perform a function or a process described herein. Alternatively, for example, according to other implementations, device 500 may be configured to perform a function or a process described herein based on the execution of hardware (processor 510, etc.).

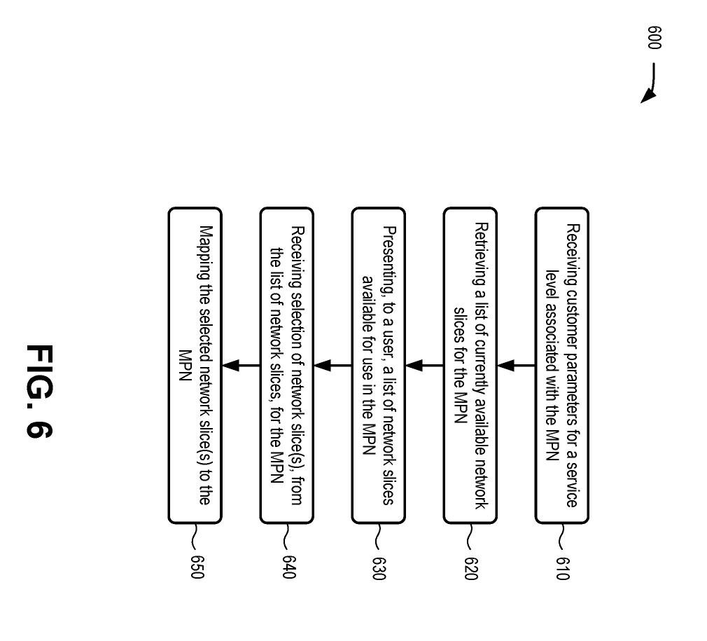

FIG. 6 is a diagram illustrating an exemplary process 600 of an embodiment of the multi-slice MPN service. More particularly, process 600 relates to configuring an MPN for use with multiple network slices, according to an implementation. In the example of FIG. 6, process 600 may be implemented by device 500. According to an exemplary implementation, a processor may execute software to perform a step (in whole or in part) of process 600, as described herein. Alternatively, a step (in whole or in part) may be performed by execution of only hardware. According to an exemplary embodiment, some or all of process 600 may be implemented by a provisioning agent 320 and/or other devices in MPN provisioning system 290.

Process 600 may include receiving customer parameters for service levels associated with the MPN (block 610). For example, a customer may use customer ordering platform 310 to define parameters for one or more service levels and/or slices to be used within an MPN. Customer ordering platform 310 may provide the customer parameters to provisioning agent 320.

Process 600 may also include retrieving a list of currently available network slices for the MPN (block 620) and presenting, to a user, a list of network slices available for use in the MPN (block 630). For example, provisioning agent 320 may provide a query to slice database 330 for available network slices that are compatible with MPNs. Slice database 330 may receive the query and respond by providing a full list of available slices supported with MPNs in the network environment 100. Provisioning agent 320 may receive the full list of available slices and display, for example, on a user interface, a dynamic slice selection list for the customer. For a new MPN, the dynamic slice selection list may include the full list of available slices. For an MPN change, the dynamic slice selection list may distinguish between slices that are already being used for the MPN (and the particular customer) and unused slices.

Process 600 may further include receiving, from the user, selection of one or more network slices, from the list of network slices, for the MPN (block 640). For example, a system engineer may select from the list of available slices to add a new slice for an existing MPN or to select slices for a new MPN according to the customer's parameters. For example, the system engineer may select a default slice and one or more other slices (e.g., a high bandwidth slice, a low latency slice, etc.) based on customer parameters. In implementations where multiple slices are used in the MPN, one slice may be designated as a default slice providing a basic service level for end devices 150, and another slice with a different service level may be designated for use with particular applications, for example.

Process 600 may additionally include mapping the selected network slices to the MPN (block 650). For example, provisioning agent 320 may calculate a configuration for the selected network slices and send the draft work order to MPN agent 340 with a validation request. The validation request may include, for example, a customer identifier, an MPN identifier, the assigned slices, and any time constraints. MPN agent 340 verify the slice selection 414 on the MPN level, such as using AI/ML predictive modeling to determine the network usage and impact of adding the assigned new slices to the existing MPN. Assuming use of the selected slice(s) on the customer's MPN is verified in the validation response, provisioning agent 320 may forward a work order assignment to line level provisioning system 350 for provisioning of individual end devices 150 to access the new network slices on the MPN.

FIG. 6 illustrates exemplary steps or operations of process 600, however, according to other exemplary embodiments, process 600 may include additional, different, and/or fewer steps or operations than those illustrated and described in relation to FIG. 6. For example, according to other exemplary embodiments, the multi-slice MPN service may use automated network slice selections performed by provisioning agent 320 based on customer parameters and/or previous customer usage.

As set forth in this description and illustrated by the drawings, reference is made to "an exemplary embodiment," "exemplary embodiments," "an embodiment," "embodiments," etc., which may include a particular feature, structure, or characteristic in connection with an embodiment(s). However, the use of the phrase or term "an embodiment," "embodiments," etc., in various places in the description does not necessarily refer to all embodiments described, nor does it necessarily refer to the same embodiment, nor are separate or alternative embodiments necessarily mutually exclusive of other embodiment(s). The same applies to the term "implementation," "implementations," etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms "a," "an," and "the" are intended to be interpreted to include one or more items. Further, the phrase "based on" is intended to be interpreted as "based, at least in part, on," unless explicitly stated otherwise. The term "and/or" is intended to be interpreted to include any and all combinations of one or more of the associated items. The word "exemplary" is used herein to mean "serving as an example." Any embodiment or implementation described as "exemplary" is not necessarily to be construed as preferred or advantageous over other embodiments or implementations.

In addition, while series of communications and blocks have been described regarding the processes illustrated in FIGS. 4A, 4B, and 6, the order of the communications and/or blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as "logic," a "component," or an "element." The logic, the component, or the element, may include, for example, hardware (e.g., processor 510, etc.), or a combination of hardware and software (e.g., software 520).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as "first," "second," "third," etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 510) of a device. A non-transitory storage medium includes one or more of the storage mediums described in relation to memory/storage 515. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known "opt-in" or "opt-out" processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method for mapping multiple slices to a single Mobile Private Network (MPN) comprising:
presenting, by a computing device, a list of network slices available for use in the MPN;
receiving, by the computing device, selection of a network slice, from the list of network slices, for the MPN, wherein the selected network slice is different than a default network slice for the MPN; and
mapping, by the computing device, the selected network slice to the MPN.

2. The method of claim 1, further comprising:
retrieving, by the computing device and from a network device, the list of currently available network slices for the MPN.

3. The method of claim 1, wherein the selected network slice has a different service level than the default network slice.

4. The method of claim 1, further comprising:
sending, by the computing device, a validation request message to validate whether the MPN can support the selected network slice; and
receiving, from a network device, a validation response message that responds to the validation request message.

5. The method of claim 4, further comprising:
performing, in response to the validation request message, predictive modeling to determine whether the selected network slice will meet a requested Quality of Service (QoS).

6. The method of claim 1, further comprising:
receiving customer parameters for the selected network slice, wherein the customer parameters include time constraints associated with the selected network slice.

7. The method of claim 6, wherein the time constraints include:
periodic times of availability for the selected network slice, or
a one-time use period for the selected network slice.

8. The method of claim 1, further comprising:
calculating, by the computing device, a configuration for the selected network slice on the MPN.

9. The method of claim 1, wherein presenting the list of network slices available for use in the MPN includes:
differentiating, in the list of network slices, unused slices and used slices in the MPN.

10. A device comprising:
a processor, wherein the processor is configured to:
present a list of network slices available for use in a Mobile Private Network (MPN);
receive selection of a network slice, from the list of network slices, for the MPN, wherein the selected network slice is different than a default network slice for the MPN; and
map the selected network slice and the default network slice to the MPN.

11. The device of claim 10, wherein the processor is further configured to:
retrieve, from a network device and via a dedicated Application Programming Interface (API), the list of currently available network slices for the MPN.

12. The device of claim 10, wherein the selected network slice has a different service level than the default network slice.

13. The device of claim 10, wherein the processor is further configured to:
send a validation request message to validate whether the MPN can support the selected network slice; and
receive, from a network device, a validation response message that responds to the validation request message.

14. The device of claim 13, wherein the validation response message is based on predictive modeling to determine whether the selected network slice will meet a requested Quality of Service (QoS).

15. The device of claim 10, wherein the processor is further configured to:
receive, from a customer ordering platform, customer parameters for a service level associated with the MPN.

16. The device of claim 10, wherein the processor is further configured to:
calculate a configuration for the selected network slice on the MPN.

17. A non-transitory computer-readable storage medium storing instructions executable by a processor of a computing device, wherein the instructions are for:
presenting, by a computing device, a list of network slices available for use in a Mobile Private Network (MPN);
receiving, by the computing device, selection of a network slice, from the list of network slices, for the MPN, wherein the selected network slice is different than a default network slice for the MPN; and
mapping, by the computing device, the selected network slice and the default network slice to the MPN.

18. The non-transitory computer-readable storage medium of claim 17, wherein the instructions are further for:
receiving, from a customer ordering platform, customer parameters for a service level associated with the MPN; and
retrieving, by the computing device and from a network device, the list of currently available network slices for the MPN.

19. The non-transitory computer-readable storage medium of claim 17, wherein the instructions are further for:
sending, by the computing device, a validation request message to validate whether the MPN can support the selected network slice; and
receiving, from a network device, a validation response message that responds to the validation request message based on predictive modeling of the MPN.

20. The non-transitory computer-readable storage medium of claim 19, wherein the predictive modeling includes time constraints for availability of the selected network slice.
